(19) United States
(12) Patent Application Publication
(10) Pub. No.: US 2013/0345833 A1
(43) Pub. Date: Dec. 26, 2013

(54) Operation Control Method and Electronic Apparatus

(71) Applicant: Lenovo (Beijing) Co., Ltd., Beijing (CN)

(72) Inventors: Mingxiang Cai, Beijing (CN); Xiaoping Zhang, Beijing (CN); Zhepeng Wang, Beijing (CN); Yaqiang Wu, Beijing (CN); Zhenyi Yang, Beijing (CN)

(21) Appl. No.: 13/919,438

(22) Filed: Jun. 17, 2013

(30) Foreign Application Priority Data
Jun. 25, 2012 (CN) 201210213780.9

(51) Int. Cl. G05B 15/02

(52) U.S. Cl. CPC G05B 15/02
USPC 700/75

(57) ABSTRACT

The present application discloses an operation control method and an electronic apparatus. The operation control method is applied to a first electronic apparatus having at least two operating modes, i.e. a first operating mode and a second operating mode. In the operation control method, the state of a second electronic apparatus is firstly detected; a corresponding control instruction is generated according to the detection result; and the first electronic apparatus is controlled to enter the first operating mode or the second operating mode according to the control instruction; if the detection result meets a preset condition, the first electronic apparatus enters the corresponding operating mode automatically, thereby it is avoided to select the mode every time the user uses the first electronic apparatus, and it is more convenient for using the first electronic apparatus.

The present application claims the priority of Chinese Patent Application No. 201210213780.9, titled “OPERATION CONTROL METHOD AND ELECTRONIC APPARATUS”, filed with the Chinese State Intellectual Property Office on Jun. 25, 2012, the entire disclosure of which are incorporated herein by reference.

### FIELD OF THE INVENTION

The present invention relates to the technical field of electronic apparatus, and in particular to an operation control method and an electronic apparatus.

### BACKGROUND OF THE INVENTION

Currently, more and more functions are integrated on a mobile terminal. For example, a remote-control function of a television or a set-top box is integrated on the mobile terminal. Specifically, the mobile terminal may communicate with a remote-controlled apparatus, so that the remote-controlled apparatus is controlled by using the mobile terminal. However, the mobile terminal has other functions in addition to the function for remotely controlling the apparatus, thus a user has to select the operating mode of the mobile terminal every time the user uses the mobile terminal. Therefore it is complicated and inconvenient for the user to use the mobile terminal.

### SUMMARY OF THE INVENTION

In order to solve the above-mentioned technical problems, an operation control method and an electronic apparatus are provided according to embodiments of the present application, to solve the problem that the existing mobile terminal is inconveniently used since it is needed to select a mode every time before the mobile terminal is used. The technical solutions are as follows.

In the present application, an operation control method is provided, the operation control method is applied to a first electronic apparatus, the first electronic apparatus has at least two operating modes including a first operating mode and a second operating mode, where the first operating mode is an operating mode that the first electronic apparatus is in when a second electronic apparatus is in a first state; the second operating mode is different from the first operating mode and is an operating mode that the first electronic apparatus is in when the second electronic apparatus is in a second state, and the second state is different from the first state, the method includes:

detecting the state of the second electronic apparatus and obtaining a detection result;

generating a corresponding control instruction according to the detection result, where the control instruction is used to control the first electronic apparatus to enter the first operating mode or the second operating mode; and

entering the first operating mode or the second operating mode according to the control instruction.

Preferably, the first state of the second electronic apparatus includes at least a first operating state, and the second state of the second electronic apparatus includes at least a second operating state, the detecting the state of the second electronic apparatus and obtaining a detection result includes:

detecting a communication state between the first electronic apparatus and the second electronic apparatus, and obtaining a first detection result if the communication state indicates that the second electronic apparatus is in the first operating state, where the first detection result is used to make the first electronic apparatus enter the first operating mode;

detecting the communication state between the second electronic apparatus and the first electronic apparatus, and obtaining a second detection result if the communication state indicates that the second electronic apparatus is in the second operating state, where the second detection result is used to make the first electronic apparatus enter the second operating mode.

Preferably, the first state of the second electronic apparatus includes a third operating state, the second state of the second electronic apparatus includes a fourth operating state, and a first power consumption of the second electronic apparatus in the third operating state is less than a second power consumption of the second electronic apparatus in the fourth operating state, the detecting the state of the second electronic apparatus and obtaining a detection result includes:

obtaining a first detection result if it is detected that the second electronic apparatus is in the third operating state, where the first detection result is used to make the first electronic apparatus enter the first operating mode;

obtaining a second detection result if it is detected that the second electronic apparatus is in the fourth operating state, where the second detection result is used to make the first electronic apparatus enter the second operating mode.

Preferably, a first control instruction is generated when the first detection result is obtained, the first control instruction is used to control the first electronic apparatus to enter the first operating mode, the first electronic apparatus in the first operating mode is adapted to receive a first predetermined operation and generate a first instruction, so that the first electronic apparatus executes the first instruction.

Preferably, a second control instruction is generated when the second detection result is obtained, the second control instruction is used to control the first electronic apparatus to enter the second operating mode, the first electronic apparatus in the second operating mode is adapted to receive a second predetermined operation, generate a second instruction and provide the second instruction to the second electronic apparatus, so that the second electronic apparatus executes the second instruction.

Preferably, the first electronic apparatus has an overlap-arranged display unit, and the method further includes, before the generating a corresponding control instruction according to the detection result,

displaying, by the display unit, operation prompt information for entering the first operating mode or the second operating mode, if it is detected that the second electronic apparatus is in the second state.

Preferably, the first electronic apparatus has a display unit and a sensing unit which are overlap-arranged, where

a first control instruction is generated when the first detection result is obtained, the first control instruction is used to control the first electronic apparatus to enter the first operating mode, and when the first electronic apparatus is in the first operating mode, the display unit outputs first prompt information, where the second electronic apparatus is switched from the first state to the second state after the sensing unit detects that the first prompt information is triggered;

a second control instruction is generated when the second detection result is obtained, the second control instruction is used to control the first electronic apparatus to enter the second operating mode, and when the first electronic apparatus is in the second operating mode, the display unit outputs second prompt information, where the second electronic apparatus is switched from the second state to the first state after the sensing unit detects that the second prompt information is triggered.

Preferably, the first electronic apparatus includes an input unit and has a third state and a fourth state, a third power consumption of the first electronic apparatus in the third state is less than a fourth power consumption of the first electronic apparatus in the fourth state, and the method further includes, before the detecting the state of the second electronic apparatus,

receiving, by the input unit, an input operation for exiting the third state which is input by an operator, when the first electronic apparatus is in the third state.

Preferably, the first electronic apparatus is in the second operating mode or the first operating mode, and the method further includes, before the detecting the state of the second electronic apparatus,

receiving state switching feedback information from the second electronic apparatus; and

the detecting the state of the second electronic apparatus includes:

detecting the state of the second electronic apparatus according to the received state switching feedback information.

According to the present application, it is further provided a first electronic apparatus which has at least two operating modes including a first operating mode and a second operating mode, where the first operating mode is an operating mode that the first electronic apparatus is in when a second electronic apparatus is in a first state; the second operating mode is different from the first operating mode and is an operating mode that the first electronic apparatus is in when the second electronic apparatus is in a second state, and the second state is different from the first state; the first electronic apparatus includes:

a communicating unit, adapted to transmit data between the first electronic apparatus and the second electronic apparatus;

a detecting unit, adapted to detect the state of the second electronic apparatus according to information provided by the communicating unit, obtain a detection result and provide the detection result to a control instruction generating unit;

the control instruction generating unit, adapted to generate a corresponding control instruction according to the detection result provided by the detecting unit and provide the control instruction to an executing unit, where the control instruction is used to control the first electronic apparatus to enter the first operating mode or the second operating mode; and

the executing unit, adapted to enter the first operating mode or the second operating mode according to the control instruction provided by the control instruction generating unit.

Preferably, the detecting unit is adapted to:

obtain a communication state between the first electronic apparatus and the second electronic apparatus by the communicating unit, and obtain a first detection result if the communication state indicates that the second electronic apparatus is in the first operating state, where the first detection result is used to make the first electronic apparatus enter the first operating mode;

obtain a second detection result if the communication state indicates that the second electronic apparatus is in the second operating mode, where the second detection result is used to make the first electronic apparatus enter the second operating mode.

Preferably, the first state of the second electronic apparatus includes a third operating state, the second state of the second electronic apparatus includes a fourth operating state, and a first power consumption of the second electronic apparatus in the third operating state is less than a second power consumption of the second electronic apparatus in the fourth operating state; where the detecting unit is adapted to:

obtain a first detection result if it is detected that the second electronic apparatus is in the third operating state, where the first detection result is used to make the first electronic apparatus enter the first operating mode;

obtain a second detection result if it is detected that the second electronic apparatus is in the fourth operating state, where the second detection result is used to make the first electronic apparatus enter the second operating mode.

Preferably, the control instruction generating unit is adapted to:

generate a first control instruction when the first detection result provided by the detecting unit is obtained, the first control instruction is used to control the first electronic apparatus to enter the first operating mode, the first electronic apparatus in the first operating mode is adapted to receive a first predetermined operation and generate a first instruction, so that the first electronic apparatus executes the first instruction.

Preferably, the control instruction generating unit is adapted to:

generate a second control instruction when the second detection result provided by the detecting unit is obtained, the second control instruction is used to control the first electronic apparatus to enter the second operating mode, the first electronic apparatus in the second operating mode is adapted to receive a second predetermined operation, generate a second instruction and provide the second instruction to the second electronic apparatus, so that the second electronic apparatus executes the second instruction.

Preferably, the first electronic apparatus has a display unit and a sensing unit which are overlap-arranged,

the display unit is further adapted to display operation prompt information for entering the first operating mode or the second operating mode if it is detected that the second electronic apparatus is in the second state; and

the sensing unit is adapted to receive an input operation of an operator.

Preferably, the first electronic apparatus has a display unit and a sensing unit which are overlap-arranged,

the control instruction generating unit is adapted to generate a first control instruction when the first detection result provided by the detecting unit is obtained, the first control instruction is used to control the first electronic apparatus to enter the first operating mode;

generate a second control instruction when the second detection result provided by the detecting unit is obtained, the second control instruction is used to control the first electronic apparatus to enter the second operating mode;

the display unit is adapted to output first prompt information when the first electronic apparatus is in the first operating mode; output second prompt information when the first electronic apparatus is in the second operating mode;

the second electronic apparatus is switched from the first state to the second state after the sensing unit detects that the first prompt information is triggered;

the second electronic apparatus is switched from the second state to the first state after the sensing unit detects that the second prompt information is triggered.

Preferably, the first electronic apparatus has a third state and a fourth state, and a third power consumption of the first electronic apparatus in the third state is less than a fourth power consumption of the first electronic apparatus in the fourth state, and the first electronic apparatus further includes:

an input unit, adapted to receive an input operation for exiting the third state which is input by an operator, when the first electronic apparatus is in the third state.

Preferably, the first electronic apparatus is in the second operating mode or the first operating mode,

the communicating unit is further adapted to receive state switching feedback information from the second electronic apparatus; and

the detecting unit is adapted to detect and obtain the state of the second electronic apparatus according to the received state switching feedback information.

It can be seen from the above technical solutions provided according to the embodiments of the present application that, the operation control method is applied to a first electronic apparatus, the first electronic apparatus has at least two operating modes, i.e., a first operating mode and a second operating mode. In the operation control method, the state of the second electronic apparatus is firstly detected, a corresponding control instruction is generated according to the detection result, and the first electronic apparatus is controlled to enter the first operating mode or the second operating mode according to the control instruction. If the detection result meets a preset condition, the first electronic apparatus enters the corresponding operating mode automatically, thereby it is avoided to select the mode every time the user uses the first electronic apparatus, and it is more convenient for using the first electronic apparatus.

### BRIEF DESCRIPTION OF THE DRAWINGS

The accompany drawings needed to be used in the description of the embodiments or the prior art will be described briefly as follows, so that the technical solutions of the embodiments of the present invention or the prior art will become clearer. It is obvious that the accompany drawings in the following description are only some embodiments of the present application, and for those skilled in the art, other accompany drawings may be obtained according to these accompany drawings without any creative work.

FIG. 1 is a schematic flowchart of an operation control method according to an embodiment of the present application;

FIG. 2 is a schematic flowchart of another operation control method according to an embodiment of the present application;

FIG. 3 is a schematic flowchart of another operation control method according to an embodiment of the present application;

FIG. 4 is a schematic flowchart of another operation control method according to an embodiment of the present application;

FIG. 5 is a schematic flowchart of another operation control method according to an embodiment of the present application;

FIG. 6 is a schematic flowchart of another operation control method according to an embodiment of the present application;

FIG. 7 is a schematic structure diagram of a first electronic apparatus according to an embodiment of the present application;

FIG. 8 is a schematic structure diagram of another first electronic apparatus according to an embodiment of the present application;

FIG. 9 is a schematic structure diagram of another first electronic apparatus according to an embodiment of the present application; and

FIG. 10 is a schematic structure diagram of another first electronic apparatus according to an embodiment of the present application.

### DETAILED DESCRIPTION OF THE INVENTION

In order to make the technical solutions of the present application be better understood by those skilled in the art, the technical solutions according to the embodiments of the present invention will be described clearly and completely as follows in conjunction with the accompany drawings in the embodiments of the present application. It is obvious that the described embodiments are only part but not all of embodiments of the present invention. All other embodiments obtained by those skilled in the art based on the embodiments in the present invention without any creative work also belong to the protection scope of the present invention.

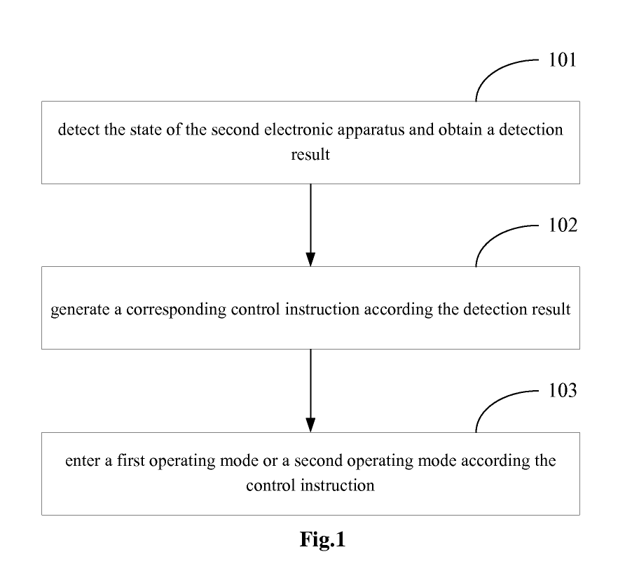

Referring to FIG. 1, a schematic flowchart of an operation control method is shown. The operation control method is applied to a first electronic apparatus which has at least two operating modes, i.e., a first operating mode and a second operating mode. The first operating mode is an operating mode that the first electronic apparatus is in when a second electronic apparatus is in a first state; the second operating mode is different from the first operating mode and is an operating mode that the first electronic apparatus is in when the second electronic apparatus is in a second state, and the second state is different from the first state. The operation control method includes the following steps.

101, detecting the state of the second electronic apparatus and obtaining a detection result.

Specifically, according to a communicating result between the second electronic apparatus and the first electronic apparatus, the states of the second electronic apparatus may be classified into two states, i.e., the first state and the second state. The first state may be a state that the second electronic apparatus fails to communicate with the first electronic apparatus, or a state that the second electronic apparatus communicates with the first electronic apparatus successfully but the information fed back to the first electronic apparatus by the second electronic apparatus is that the second electronic apparatus is not in an operating state. That is, the first state may be an operating state such as a power off state, a standby state or a sleep state; or the first state may be a power off state.

The second state may be a state that the second electronic apparatus communicates with the first electronic apparatus successfully, or a state that the information fed back to the first electronic apparatus by the second electronic apparatus is that the second electronic apparatus is in an operating state. That is, the second state may be a power on state (a normal operating state); or the second state may be a power on state, a standby state or a sleep state.

Of course, the state of the second electronic apparatus may also be detected according to a communicating result between the first electronic apparatus and the second electronic apparatus. In accordance with the power consumption, the states of the second electronic apparatus may be classified into two states, i.e., a first state and a second state. Specifically, a first power consumption of the second electronic apparatus in the first state is less than a second power consumption of the second electronic apparatus in the second state. The first state may be a state that the second electronic apparatus is in an operating state such as a sleep state, a standby state or a power off state, or the first state is a standby state or a sleep state; and the second state may be a state that the second electronic apparatus is in a power on state (the normal operating state).

102, generating a corresponding control instruction according to the detection result, where the control instruction is used to control the first electronic apparatus to enter the first operating mode or the second operating mode.

Specifically, a first control instruction may be generated if it is detected that the second electronic apparatus is in the first state, where the first control instruction is used to control the first electronic apparatus to enter the first operating mode; a second control instruction may be generated if it is detected that the second electronic apparatus is in the second state, where the second control instruction is used to control the first electronic apparatus to enter the second operating mode, the second operating mode is different from the first operating mode.

103, entering the first operating mode or the second operating mode according to the control instruction.

The operation control method provided in the embodiment is applied to a first electronic apparatus which has at least two operating modes, i.e., a first operating mode and a second operating mode. The state of the second electronic apparatus is firstly detected, a corresponding control instruction is generated according to the detection result and the first electronic apparatus is controlled to enter the first operating mode or the second operating mode according to the control instruction. If the detection result meets a preset condition, the first electronic apparatus enters the corresponding operating mode automatically, thereby it is avoided to select the mode every time the user uses the first electronic apparatus, thus the operation of the first electronic apparatus is simpler and it is more convenient for using the first electronic apparatus.

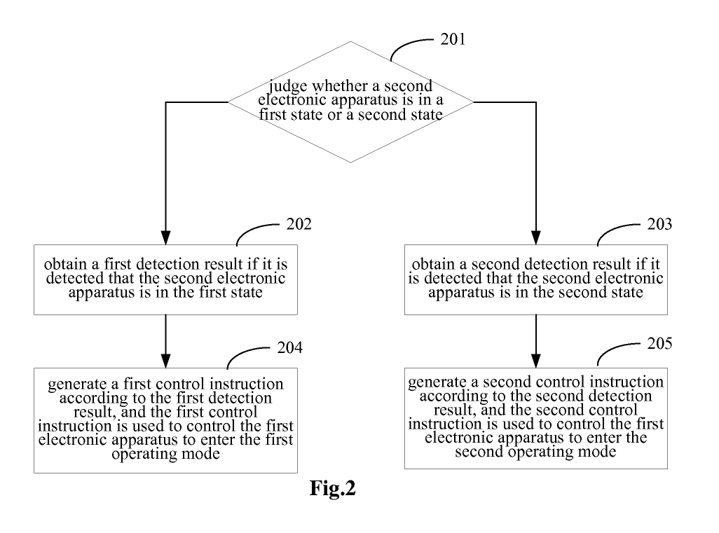

Referring to FIG. 2, a schematic flowchart of another operation control method is shown. The operation control method is applied to a first electronic apparatus which has at least two operating modes, i.e., a first operating mode and a second operating mode. The first operating mode is an operating mode that the first electronic apparatus is in when a second electronic apparatus is in a first state; the second operating mode is different from the first operating mode and is an operating mode that the first electronic apparatus is in when the second electronic apparatus is in a second state, and the first state is different from the second state. Specifically, the first electronic apparatus may be a mobile terminal, the mobile terminal includes at least a Tablet Personal Computer (Pad), a feature phone, a smart phone and a

Personal Digital Assistant (PDA), and the second electronic apparatus may be an apparatus which can be remote-controlled, such as a television or a top-box.

The operation control method may include the following steps.

201, judging whether the second electronic apparatus is in the first state or the second state.

In the embodiment, the first operating state of the second electronic apparatus is a power off state, and correspondingly, the second operating state is a power on state, a standby state or a sleep state; or, the first operating state of the second electronic apparatus is a power off state, a standby state or a sleep state, and correspondingly, the second operating state is a power on state.

202, obtaining a first detection result if it is detected that the second electronic apparatus is in the first state.

In the embodiment, the operating state of the second electronic apparatus may be judged according to a communicating result between the second electronic apparatus and the first electronic apparatus. If the second electronic apparatus fails to communicate with the first electronic apparatus, or the second electronic apparatus communicates with the first electronic apparatus successfully but the feedback information fed back to the first electronic apparatus is that the second electronic apparatus is not in an operating state, it is judged that the second electronic apparatus is in the first state which includes a first operating state, the first operating state may be a power off state.

Alternatively, the operating state of the second electronic apparatus may be judged according to a communication state between the first electronic apparatus and the second electronic apparatus (such operating state is classified according to the power consumption of the second electronic apparatus). In this case, the first state includes a third operating state and the third operating state may be a state of low power consumption, such as a power off state, a standby state and a sleep state.

The first detection result corresponds to the first operating mode of the first electronic apparatus.

203, obtaining a second detection result if it is detected that the second electronic apparatus is in the second state.

It is judged that the second electronic apparatus is in a second operating state if the second electronic apparatus communicates with the first electronic apparatus successfully. The second operating state may be a power on state, a standby state or a sleep state.

Alternatively, the operating state of the second electronic apparatus is determined according to a communication state between the first electronic apparatus and the second electronic apparatus (such operating state is classified according to the power consumption). In this case, a fourth operating state included in the second state may be a power on state of high power consumption.

The second detection result corresponds to the second operating mode of the first electronic apparatus.

204, generating a first control instruction according to the obtained first detection result, the first control instruction is used to control the first electronic apparatus to enter the first operating mode; the first electronic apparatus in the first operating mode is adapted to receive a first predetermined operation and generate a first instruction, so that the first electronic apparatus executes the first instruction.

In the embodiment, the first electronic apparatus in the first operating mode receives the first predetermined operation and generate the corresponding first instruction, so that the first electronic apparatus executes the first instruction. For example, if the first electronic apparatus is a Pad, the first operating mode thereof is an operating mode in which the function of the Pad itself can be implemented; the operating mode for the function of the mobile terminal itself may be an operating mode in which an application program unrelated to the second electronic apparatus is run on the mobile terminal, for example, browsing web pages, playing games or the like on the Pad.

205, generating a second control instruction according to the obtained second detection result, and the second control instruction is used to control the first electronic apparatus to enter the second operating mode. The first electronic apparatus in the second operating mode is adapted to receive a second predetermined operation, generate a second instruction and provide the second instruction to the second electronic apparatus, so that the second electronic apparatus executes the second instruction.

Specifically, for example, the first electronic apparatus is a Pad and the second electronic apparatus is a television, then the process in step 205 may be that the Pad, as a remote controller of the television, controls the television to change channels, controls the volume of the television or controls the operating state of the television (power on or power off).

In the embodiment, the first electronic apparatus in the second operating mode receives the second predetermined operation, generate the corresponding second instruction and provide the second instruction to the second electronic apparatus, so that the second electronic apparatus executes the second instruction.

Also provided that the first electronic apparatus is a Pad, and the Pad has a second operating mode. The Pad in the second operating mode can control the second electronic apparatus, that is, the second operating mode of the Pad is a remote-control mode.

The operation control method provided in the embodiment is applied to a first electronic apparatus which has at least two operating modes, i.e., a first operating mode and a second operating mode. In the method, the operating state of the second electronic apparatus is detected; the first electronic apparatus may enter the first operating mode automatically if it is detected that the second electronic apparatus is in a first state; and the first electronic apparatus may enter the second operating mode automatically if it is detected that the second electronic apparatus is in a second state. Thereby it is avoided to select the mode every time the user uses the first electronic apparatus, and it is more convenient for using the first electronic apparatus.

Referring to FIG. 3, a schematic flowchart of another operation control method is shown. The operation control method is applied to a first electronic apparatus which has at least two operating modes, i.e., a first operating mode and a second operating mode. The first operating mode is an operating mode that the first electronic apparatus is in when a second electronic apparatus is in a first state; the second operating mode is different from the first operating mode and is an operating mode that the first electronic apparatus is in when the second electronic apparatus is in a second state, and the first state is different from the second state.

The first electronic apparatus may be a mobile terminal, and has a display unit and a sensing unit which are overlap-arranged (such as a touch screen). Specifically, the display unit and the sensing unit may be a display unit and a touch sensing unit which are independent and overlap-arranged, or may be a combination of a display unit and a sensing unit such as an in-cell touch screen. The second electronic apparatus may be a terminal apparatus such as a television.

The operation control method may include the following steps.

301, judging whether the second electronic apparatus is in a first state or a second state.

Specifically, the state of the second electronic apparatus may be judged by detecting a communication state between the first electronic apparatus and the second electronic apparatus. Of course, the state of the second electronic apparatus may be judged by using other ways, such as determining the state of the second electronic apparatus according to the power consumption of the second electronic apparatus.

1) Determining the state of the second electronic apparatus by detecting the communicating result between the first electronic apparatus and the second electronic apparatus.

If the second electronic apparatus fails to communicate with the first electronic apparatus, or if the second electronic apparatus communicates with the first electronic apparatus successfully but feedback information fed back to the first electronic apparatus is that the second electronic apparatus is not in an operating state, it is judged that the second electronic apparatus is in the first state, the first state includes a first operating state, and the first operating state may be a power off state; and

if the second electronic apparatus communicates with the first electronic apparatus successfully, it is judged that the second electronic apparatus is in the second state, the second state includes a second operating state, and the second operating state may be a power on state, a standby state or a sleep state.

2) Determining the operating state of the second electronic apparatus according to the power consumption of the second electronic apparatus.

In this case, the first state of the second electronic apparatus includes a third operating state of low power consumption, the third operating state may be a power off state, a standby state or a sleep state; and

the second state of the second electronic apparatus includes a fourth operating state of high power consumption, the fourth operating state may be a power on state.

302, obtaining a first detection result if it is detected that the second electronic apparatus is in the first state.

303, obtaining a second detection result if it is detected that the second electronic apparatus is in the second state.

304, generating a first control instruction according to the obtained first detection result, and the first control instruction is used to control the first electronic apparatus to enter the first operating mode; the first electronic apparatus in the first operating mode is adapted to receive a first predetermined operation and generate a first instruction, so that the first electronic apparatus executes the first instruction.

In the embodiment, the first electronic apparatus in the first operating mode receives the first predetermined operation and generates the first instruction, so that the first electronic apparatus executes the first instruction. For example, in the case that the first electronic apparatus is a Pad, the first operating mode thereof is an operating mode in which the function of the Pad itself can be implemented.

305, displaying operation prompt information for entering the first operating mode or the second operating mode when the second detection result is detected and obtained.

Specifically, if it is detected that the second electronic apparatus is in the second state, for example, if the second electronic apparatus is in the second operating state or the fourth operating state, prompt information is displayed on the display unit of the first electronic apparatus, and the prompt information is used to prompt the user to enter the first operating mode or the second operating mode.

After the prompt information for entering the second operating mode is triggered, the first electronic apparatus enters the second operating mode; and after the prompt information for entering the first operating mode is triggered, the first electronic apparatus enters the first operating mode.

Moreover, if it is detected that the second electronic apparatus is in the second state (the second electronic apparatus is in the second operating state or the fourth operating state), a mixed application page of the first operating mode and the second operating mode may be displayed on the display unit of the first electronic apparatus.

Specifically, if an input operation is performed on the application page belonging to the first operating mode, the first electronic apparatus may be controlled to enter the first operating mode; and if an input operation is performed on the application page belonging to the second operating mode, the first electronic apparatus may be controlled to enter the second operating mode.

The operation control method provided in the embodiment is applied to a first electronic apparatus which has at least two operating modes, i.e., a first operating mode and a second operating mode. In the method, an operating state of a second electronic apparatus is detected; the first electronic apparatus can enter the first operating mode automatically if it is detected that the second electronic apparatus is in a first state (for example, power off) or the second electronic apparatus fails to communicate with the first electronic apparatus (for example, the second electronic apparatus is in an uncontrollable range of the first electronic apparatus); and operation prompt information for entering the first operating mode or the second operating mode may be displayed to the user if it is detected that the second electronic apparatus is in the second state. Therefore the first electronic apparatus enters the first operating mode automatically if the first electronic apparatus can not communicate with the second electronic apparatus. Thereby it is avoided to select the mode every time the user uses the first electronic apparatus, and it is more convenient for using the first electronic apparatus.

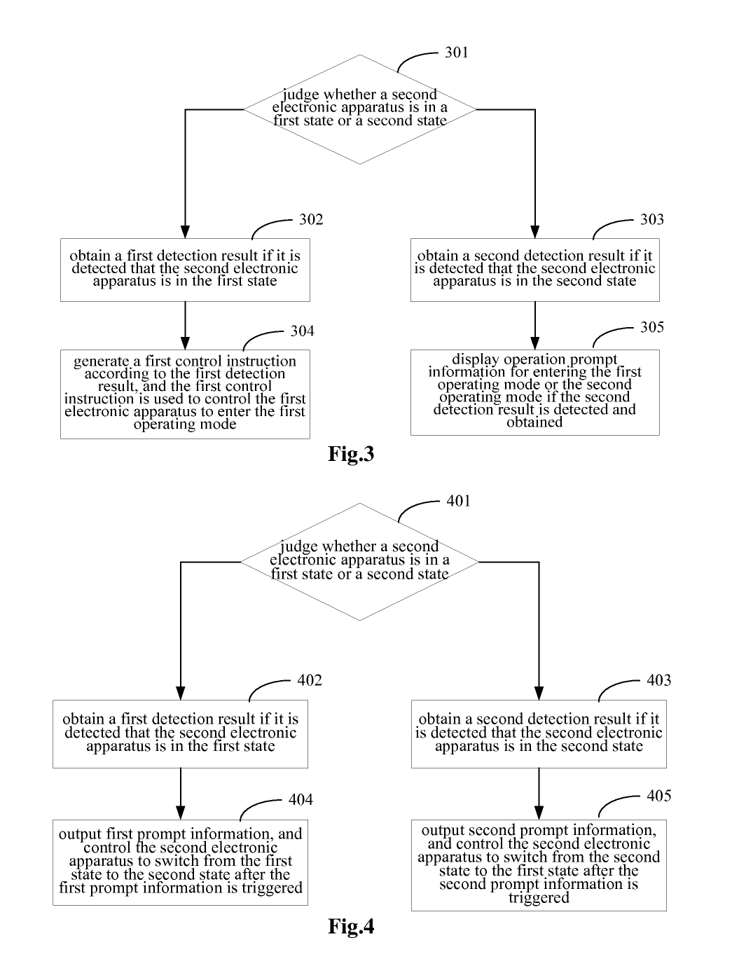

Referring to FIG. 4, a schematic flowchart of another operation control method is shown. The operation control method is applied to a first electronic apparatus which has at least two operating modes, i.e., a first operating mode and a second operating mode. The first operating mode is an operating mode that the first electronic apparatus is in when a second electronic apparatus is in a first state; the second operating mode is different from the first operating mode and is an operating mode that the first electronic apparatus is in when the second electronic apparatus is in a second state, and the first state is different from the second state.

The first electronic apparatus has a display unit and a sensing unit which are overlap-arranged (such as an electronic apparatus having a touch screen); and the second electronic apparatus may be a terminal apparatus which can be remote-controlled, such as a television.

The operation control method includes the following steps.

401, judging whether the second electronic apparatus is in the first state or the second state.

Specifically, in the embodiment, the following two ways for determining the state of the second electronic apparatus are provided.

1) Determining the state of the second electronic apparatus by detecting a communicating result between the first electronic apparatus and the second electronic apparatus.

On a basis that the first electronic apparatus communicates with the second electronic apparatus successfully, the state of the second electronic apparatus is judged based on a case that whether the second electronic apparatus receives multi-media information.

If it is detected that the second electronic apparatus does not receive the multi-media information, it is judged that the second electronic apparatus is in the first state, where the first state may be a standby state or a sleep state; and

if it is detected that the second electronic apparatus is receiving the multi-media information, it is judged that the second electronic apparatus is in the second state, where the second state may be a power on state.

2) Determining the state of the second electronic apparatus according to the power consumption of the second electronic apparatus.

If it is detected that the second electronic apparatus is in a low power consumption state, it is judged that the second electronic apparatus is in the first state, the first state includes a third operating state, where the third operating state may be a standby state, a sleep state or a power off state; and

if it is detected that the second electronic apparatus is in a high power consumption state, it is judged that the second electronic apparatus is in the second state, the second state includes a fourth operating state, where the fourth operating state may be a power on state.

402, obtaining a first detection result if it is judged that the second electronic apparatus is in the first state.

403, obtaining a second detection result if it is judged that the second electronic apparatus is in the second state.

404, generating a first control instruction when the first detection result is obtained, the first control instruction is used to control the first electronic apparatus to enter the first operating mode; when the first electronic apparatus is in the first operating mode, the display unit outputs first prompt information; and the second electronic apparatus is switched from the first state to the second state after the sensing unit detects that the first prompt information is triggered.

When it is judged that the second electronic apparatus is in the first state (the first operating state or the third operating state), the first prompt information (power on prompt information) is displayed on the display unit of the first electronic apparatus; a corresponding control instruction is generated and provided to the second electronic apparatus after the user triggers the first prompt information; and the second electronic apparatus is switched from the first state (the standby state, the sleep state or the power off state) to the second state (the power on state) as a result of executing the control instruction.

It should be noted that, in the case that the second electronic apparatus is in the power off state, a communicating unit in the second electronic apparatus is powered; that is, the communicating unit in the second electronic apparatus can receive a wireless communicating signal transmitted from the first electronic apparatus, and control the second electronic apparatus to be powered on according to the received wireless communicating signal. For example, a pulse signal is generated by using the received wireless communicating signal transmitted from the first electronic apparatus, and the pulse signal may control the second electronic apparatus to be powered on.

405, generating a second control instruction when the second detection result is obtained, the second control instruction is used to control the first electronic apparatus to enter the second operating mode; when the first electronic apparatus is in the second operating mode, the display unit outputs second prompt information; and the second electronic apparatus is switched from the second state to the first state after the sensing unit detects that the second prompt information is triggered.

When it is judged that the second electronic apparatus is in the second state (the power on state), the second prompt information (power off prompt information) is displayed on the display unit of the first electronic apparatus; a corresponding control instruction is generated and provided to the second electronic apparatus after the user triggers the second prompt information via the sensing unit; and the second electronic apparatus is switched from the second state (the power on state) to the first state (the standby state or the sleep state) as a result of executing the control instruction.

It should be noted that, in the embodiment, the first operating mode and the second operating mode of the first electronic apparatus are different from those of the first electronic apparatus in FIG. 2 and FIG. 3. Specifically, for example, the first electronic apparatus is a mobile terminal having a touch screen; the mobile terminal may implement all functions of the mobile terminal as a terminal, and further may control the second electronic apparatus as a remote-controller. The first electronic apparatus may have the first operating mode (in which the first prompt information is output) and the second operating mode (in which the second prompt information is output) no matter the first electronic apparatus operates as a terminal or a remote-controller.

In the operation control method provided in the embodiment, different state of the second electronic apparatus can be detected; different prompt information is displayed on the first electronic apparatus when the second electronic apparatus is in the different state; and the second electronic apparatus may be controlled to switch the state by triggering the prompt information. Specifically, if it is detected that the second electronic apparatus is in the first state, the first electronic apparatus outputs the first prompt information, and the second electronic apparatus is controlled to switch from the first state to the second state after the first prompt information is triggered; if it is detected that the second electronic apparatus is in the second state, the first electronic apparatus outputs the second prompt information, and the second electronic apparatus is controlled to switch from the second state to the first state after the second prompt information is triggered. During the process, the user needs not to select or switch the operating mode of the first electronic apparatus, thus the operation of the user is simplified and it is convenient for the user to use the first electronic apparatus.

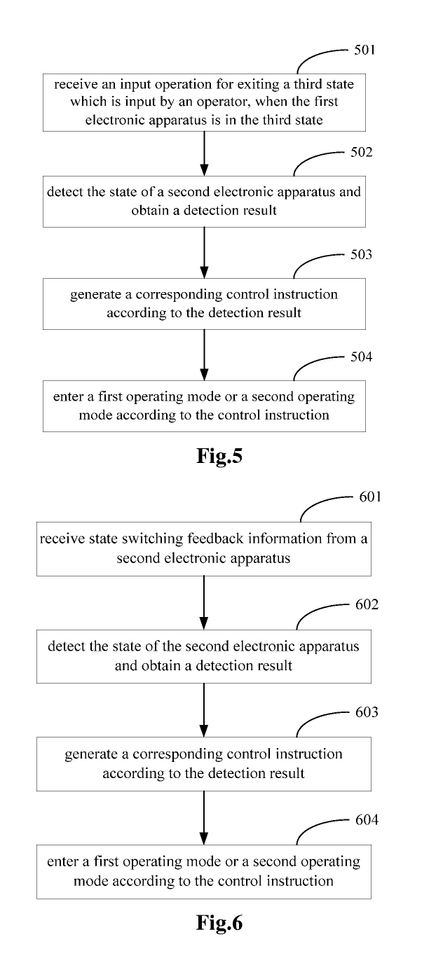

Referring to FIG. 5, a schematic flowchart of another operation control method is shown. The operation control method is applied to a first electronic apparatus which has at least two operating modes, i.e., a first operating mode and a second operating mode. The first operating mode is an operating mode that the first electronic apparatus is in when a second electronic apparatus is in a first state; the second operating mode is different from the first operating mode and is an operating mode that the first electronic apparatus is in when the second electronic apparatus is in a second state, and the first state is different from the second state. Moreover, the first electronic apparatus has a third state and a fourth state, and a third power consumption of the first electronic apparatus in the third state is less than a fourth power consumption of the first electronic apparatus in the fourth state.

The operation control method includes the following steps.

501, receiving an input operation for exiting the third state which is input by an operator, when the first electronic apparatus is in the third state.

Specifically, the third state may be a sleep state of low power consumption, and in this case, an input unit receives the input operation for exiting the sleep state which is input by the operator (such as a wake-up input operation).

The input unit may be a sensing unit, a touch-sensing unit or other sensors, and also may be an input unit which can receive input information of a user, such as a press key input unit and an audio input unit.

502, detecting the state of the second electronic apparatus and obtaining a detection result.

In the embodiment, the first state of the second electronic apparatus and the second state of the second electronic apparatus may be any one of the first state and the second state which are mentioned in all the above method embodiments respectively.

503, generating a corresponding control instruction according to the detection result, and the control instruction is used to control the first electronic apparatus to enter the first operating mode or the second operating mode.

The first operating mode of the first electronic apparatus and the second operating mode of the first electronic apparatus may be any one of the first operating mode and the second operating mode mentioned in all the above method embodiments, and correspond to the specific state types of the first state and the second state of the second electronic apparatus.

504, entering the first operating mode or the second operating mode according to the control instruction.

In the operation control method of the first electronic apparatus provided in the embodiment, whether the first electronic apparatus is to enter the first operating mode or the second operating mode is judged when the input operation for switching the state of the first electronic apparatus is received, then the first electronic apparatus enters a corresponding operating mode automatically according to the corresponding judging result, thereby it is avoided to select the mode every time the user uses the first electronic apparatus, thus the operation of the first electronic apparatus is simpler and it is more convenient for using the first electronic apparatus.

Referring to FIG. 6, a schematic flowchart of another operation control method is shown. The operation control method is applied to a first electronic apparatus which has at least two operating modes, i.e., a first operating mode and a second operating mode. The first operating mode is an operating mode that the first electronic apparatus is in when a second electronic apparatus is in a first state; the second operating mode is different from the first operating mode and is an operating mode that the first electronic apparatus is in when the second electronic apparatus is in a second state, and the first state is different from the second state. Moreover, the first electronic apparatus has a third state and a fourth state, and a third power consumption of the first electronic apparatus in the third state is less than a fourth power consumption of the first electronic apparatus in the fourth state.

The operation control method includes the following steps.

601, receiving state switching feedback information from the second electronic apparatus.

In the embodiment, the second electronic apparatus transmits state switch feedback information to the first electronic apparatus actively after switching the state, so that the first electronic apparatus obtains the state information of the second electronic apparatus. For example, when the user presses a switch button of the second electronic apparatus to make the second electronic apparatus be switched from a power off state to a power on state, the second electronic apparatus transmits to the first electronic apparatus feedback information that the second electronic apparatus is switched from the power off state to the power on state. In this case, the second electronic apparatus has a feedback information transmitting module to implement the transmission of the feedback information.

602, detecting the state of the second electronic apparatus according to the received state switch feedback information and obtaining a detection result.

The first state of the second electronic apparatus and the second state of the second electronic apparatus may be any one of the first state and the second state which are mentioned in all the above method embodiments respectively.

603, generating a corresponding control instruction according to the detection result, and the control instruction is used to control the first electronic apparatus to enter the first operating mode or the second operating mode.

The first operating mode of the first electronic apparatus and the second operating mode of the first electronic apparatus may be any one of the first operating mode and the second operating mode which are mentioned in all the above method embodiments, and correspond to the specific state types of the first state and the second state of the second electronic apparatus.

604, entering the first operating mode or the second operating mode according to the control instruction.

In the operation control method of the first electronic apparatus provided in the embodiment, the state switching information fed back by the second electronic apparatus is received when the first electronic apparatus is in an operating state (the first operating mode or the second operating mode). The state switching information is a trigger condition for switching the operating mode of the first electronic apparatus. Then, the state of the second electronic apparatus is judged according to the state switching information, and the first electronic apparatus enters the corresponding operating mode automatically according to the corresponding judging result. Thereby it is avoided to select the mode every time the user uses the first electronic apparatus, thus the operation of the first electronic apparatus is simpler, and it is more convenient for using the first electronic apparatus.

Corresponding to the above embodiments of the operation control method, it is further provided an electronic apparatus for using the operation control method according to the present application.

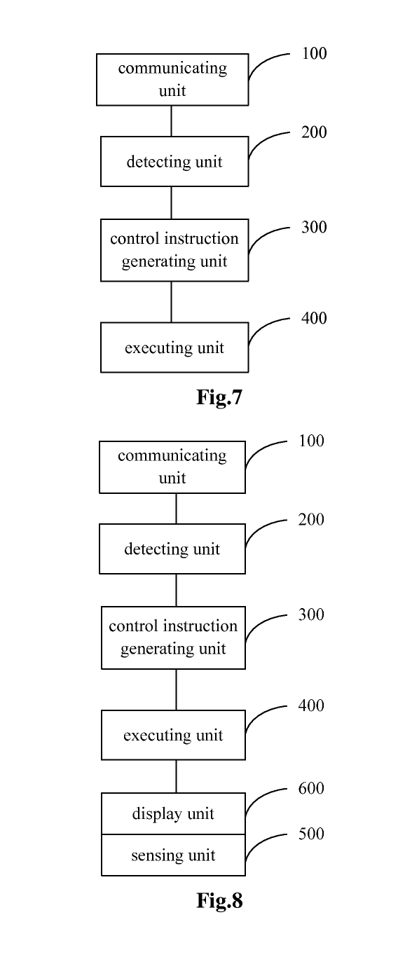

Referring to FIG. 7, a schematic structure diagram of a first electronic apparatus is shown. The first electronic apparatus has at least two operating modes, i.e., a first operating mode and a second operating mode. The first operating mode is an operating mode that the first electronic apparatus is in when a second electronic apparatus is in a first state; the second operating mode is different from the first operating mode and is an operating mode that the first electronic apparatus is in when the second electronic apparatus is in a second state, and the first state is different from the second state.

The first electronic apparatus may be a mobile terminal apparatus such as a Pad; and the second electronic apparatus may be an electronic apparatus which can be remote-controlled, such as a television and a top-box.

The first electronic apparatus includes a communicating unit 100, a detecting unit 200, a control instruction generating unit 300 and an executing unit 400.

The communicating unit 100 is adapted to transmit data between the first electronic apparatus and the second electronic apparatus.

Specifically, the communicating unit is a wireless communicating module and specifically may be a wireless communicating module such as a Bluetooth module, an infrared module or a WiFi module.

The detecting unit 200 is adapted to detect the state of the second electronic apparatus according to information provided by the communicating unit, obtain a detection result and provide the detection result to the control instruction generating unit.

In a specific implementation, the states of the second electronic apparatus may be classified into a first state and a second state according to the power consumption of the second electronic apparatus, and a first power consumption of the second electronic apparatus in the first state is less than a second power consumption of the second electronic apparatus in the second state. The states of the second electronic apparatus may also be classified into a first state and a second state according to a communicating result between the first electronic apparatus and the second electronic apparatus. Specifically, the first state may be a state that the first electronic apparatus fails to communicate with the second electronic apparatus, or a state that the first electronic apparatus communicates with the second electronic apparatus successfully but the second electronic apparatus feeds back to the first electronic apparatus feedback information that the second electronic apparatus is not in an operating state.

The second state may be a state that the first electronic apparatus communicates with the second electronic apparatus successfully, or a state that the first electronic apparatus receives feedback information that the second electronic apparatus is in an operating state which is fed back to the first electronic apparatus from the second electronic apparatus.

Specifically, the detecting unit may judge the state of the second electronic apparatus by detecting the communicating result between the first electronic apparatus and the second electronic apparatus.

The detecting unit is adapted to: obtain a first detection result if it is detected that the second electronic apparatus is in the first state, and the first detection result is used to make the first electronic apparatus enter the first operating mode; and obtain a second detection result if it is detected that the second electronic apparatus is in the second state, the second detection result is used to make the first electronic apparatus enter the second operating mode.

The control instruction generating unit 300 is adapted to generate a corresponding control instruction according to the detection result provided by the detecting unit and provide the detection result to the executing unit, the control instruction is used to control the first electronic apparatus to enter the first operating mode or the second operating mode.

In a specific implementation, the control generating unit is adapted to:

(1) generate a first control instruction when the first detection result provided by the detecting unit is obtained, the first control instruction is used to control the first electronic apparatus to enter the first operating mode, and the first electronic apparatus in the first operating mode is adapted to receive a first predetermined operation and generate a first instruction, so that the first electronic apparatus executes the first instruction;

(2) generate a second control instruction when the second detection result provided by the detecting unit is obtained, the second control instruction is used to control the first electronic apparatus to enter the second operating mode, and the first electronic apparatus in the second operating mode is adapted to receive a second predetermined operation, generate a second instruction and provide the second instruction to the second electronic apparatus, so that the second electronic apparatus executes the second instruction.

Specifically, for example, the first electronic apparatus is a mobile terminal, the first operating mode may be an operating mode in which all functions of the mobile terminal can be implemented; and the second operating mode may be a remote-controller mode in which the second electronic apparatus can be controlled.

The executing unit 400 is adapted to enter the first operating mode or the second operating mode according to the control instruction provided by the control instruction generating unit.

The detecting unit, the control instruction generating unit and the executing unit may be integrated into a processor of the first electronic apparatus, and the first electronic apparatus further includes a storage connected to the processor for storing all data generated during the operation control of the electronic apparatus.

The electronic apparatus provided in the embodiment has at least two operating modes, i.e., a first operating mode and a second operating mode. In the embodiment, the state of the second electronic apparatus is detected by the detecting unit, the corresponding control instruction is generated by the control instruction generating unit according to the detection result of the detecting unit, and the control instruction is executed by the executing unit to automatically control the first electronic apparatus to enter the corresponding operating mode. Thereby it is avoided to select the mode every time the user uses the first electronic apparatus, thus the operation of the first electronic apparatus is simpler, and it is more convenient for using the first electronic apparatus.

Referring to FIG. 8, a schematic structure diagram of another first electronic apparatus is shown. The first electronic apparatus has at least two operating modes, i.e., a first operating mode and a second operating mode. The first operating mode is an operating mode that the first electronic apparatus is in when a second electronic apparatus is in a first state; the second operating mode is different from the first operating mode and is an operating mode that the first electronic apparatus is in when the second electronic apparatus is in a second state, and the first state is different from the second state.

The first electronic apparatus includes a communicating unit 100, a detecting unit 200, a control instruction generating unit 300, an executing unit 400, a sensing unit 500 and a display unit 600.

The communicating unit 100 is adapted to transmit data between the first electronic apparatus and the second electronic apparatus.

The detecting unit 200 is adapted to detect the state of the second electronic apparatus according to information provided by the communicating unit, obtain a detection result and provide the detection result to the control instruction generating unit.

Specifically, the detecting unit is adapted to:

obtain a first detection result if it is detected that the second electronic apparatus is in the first state, the first detection result is used to make the first electronic apparatus enter the first operating mode; obtain a second detection result if it is detected that the second electronic apparatus is in the second state, the second detection result is used to make the first electronic apparatus enter the second operating mode.

The control instruction generating unit 300 is adapted to generate a corresponding control instruction according to the detection result provided by the detecting unit and provide the control instruction to the executing unit, the control instruction is used to control the first electronic apparatus to enter the first operating mode or the second operating mode.

Specifically, the control instruction generating unit is adapted to: generate a first control instruction when the first detection result provided by the detecting unit is obtained, the first control instruction is used to control the first electronic apparatus to enter the first operating mode;

generate a second control instruction when the second detection result provided by the detecting unit is obtained, the second control instruction is used to control the first electronic apparatus to enter the second operating mode.

The executing unit 400 is adapted to enter the first operating mode or the second operating mode according to the control instruction provided by the control instruction generating unit.

The sensing unit 500 is adapted to receive an input operation of an operator.

The display unit 600 is adapted to display information.

Specifically, the display unit and the sensing unit may be two independent units which are overlap-arranged, or may be a combination of a display unit and a touch sensing unit, such as an in-cell touch screen.

In a specific implementation, the display unit is adapted to:

output first prompt information when the first electronic apparatus is in the first operating mode; and the second electronic apparatus is controlled to switch from the first state to the second state after the first prompt information is triggered.

For example, when the second electronic apparatus is in the first state (the third operating state such as a standby state, a sleep state or a power off state), the display unit displays the first prompt information (power on prompt information).

Alternatively, when the second electronic apparatus is in the first state (such as a standby state or a sleep state), the display unit displays the first prompt information (power on prompt information).

The display unit is also adapted to output second prompt information when the first electronic apparatus is in the second operating mode, and the second electronic apparatus is controlled to switch from the second state to the first state after the second prompt information is triggered.

For example, when the second electronic apparatus is in the second state (such as a power on state), the display unit displays the second prompt information (power off prompt information). In this case, the first or second operating mode of the first electronic apparatus is that the first electronic apparatus can output different prompt information according to different states of the second electronic apparatus.

Specifically, an operator triggers the prompt information displayed on the display unit via the sensing unit.

The first electronic apparatus provided in the embodiment detects the state of the second electronic apparatus; and displays the corresponding prompt information on the display unit according to different states of the second electronic apparatus. Thus an operator may trigger the prompt information to control the second electronic apparatus to switch the state.

Preferably, the display unit 600 in FIG. 8 is further adapted to display selection operation prompt information for entering the first operating mode or the second operating mode, if it is detected that the second electronic apparatus is in the second state (a standby state, a power on state or a sleep state).

Alternatively, the display unit displays a mixed application page of the first operating mode and the second operating mode when the detecting unit detects that the second electronic apparatus is in the second state (a standby state, a power on state or a sleep state).

Specifically, the first electronic apparatus in the first operating mode is adapted to receive a first predetermined operation and generate a first instruction, so that the first electronic apparatus executes the first instruction; and the first electronic apparatus in the second operating mode is adapted to receive a second predetermined operation, generate a second instruction and provide the second instruction to the second electronic apparatus, so that the second electronic apparatus executes the second instruction.

The sensing unit 500 is adapted to receive an input operation of an operator.

The operator performs an input operation corresponding to operation prompt information via the sensing unit according to the operation prompt information displayed by the display unit 600, so that the first electronic apparatus enters the corresponding operating mode.

For example, the operation prompt information is “whether to enter the first operating mode”, if the operator selects “yes”, the operator inputs the input operation corresponding to “yes” via the sensing unit, and the first electronic apparatus enters the first operating mode.

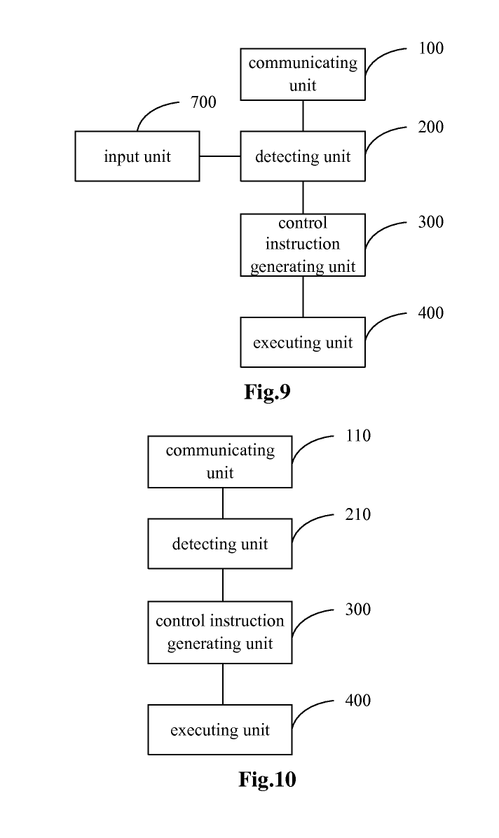

Referring to FIG. 9, a schematic structure diagram of another first electronic apparatus is shown.

The first electronic apparatus has at least two operating modes, i.e., a first operating mode and a second operating mode. The first operating mode is an operating mode that the first electronic apparatus is in when a second electronic apparatus is in a first state; the second operating mode is different from the first operating mode and is an operating mode that the first electronic apparatus is in when the second electronic apparatus is in a second state, and the first state is different from the second state.

The first electronic apparatus has a third state and a fourth state, and a third power consumption of the first electronic apparatus in the third state is less than a fourth power consumption of the first electronic apparatus in the fourth state.

The first electronic apparatus includes a communicating unit 100, a detecting unit 200, a control instruction generating unit 300, an executing unit 400 and an input unit 700.

The input unit 700 is adapted to receive an input operation for exiting the third state which is input by an operator, when the first electronic apparatus is in the third state.

The communicating unit 100 is adapted to transmit data between the first electronic apparatus and the second electronic apparatus.

The detecting unit 200 is adapted to detect the state of the second electronic apparatus according to information provided by the communicating unit, obtain a detection result and provide the detection result to the control instruction generating unit.

The control instruction generating unit 300 is adapted to generate a corresponding control instruction according to the detection result provided by the detection result, and provide the control instruction to the executing unit; the control instruction is used to control the first electronic apparatus to enter the first operating mode or the second operating mode.

The executing unit 400 is adapted to enter the first operating mode or the second operating mode according to the control instruction provided by the control instruction generating unit.

The first electronic apparatus provided in the embodiment judges whether the first electronic apparatus enters the first operating mode or the second operating mode when receiving the input operation for switching the state of the first electronic apparatus, then the first electronic apparatus enters the corresponding operating mode according to the corresponding judging result automatically. Thereby it is avoided to select the mode every time the user uses the first electronic apparatus, thus the operation of the first electronic apparatus is simpler, and it is more convenient for using the first electronic apparatus.

Referring to FIG. 10, a schematic structure diagram of another first electronic apparatus is shown.

The first electronic apparatus has at least two operating modes, i.e., a first operating mode and a second operating mode. The first operating mode is an operating mode that the first electronic apparatus is in when a second electronic apparatus is in a first state; the second operating mode is different from the first operating mode and is an operating mode that the first electronic apparatus is in when the second electronic apparatus is in a second state, and the first state is different from the second state.

The first electronic apparatus includes a communicating unit 110, a detecting unit 210, a control instruction generating unit 300 and an executing unit 400.

The communicating unit 110 is adapted to receive state switching feedback information from the second electronic apparatus.

The detecting unit 210 is adapted to detect and obtain the state of the second electronic apparatus according to the received state switching feedback information and provide the state of the second electronic apparatus to the control instruction generating unit.

The control instruction generating unit 300 is adapted to generate a corresponding control instruction according to the detection result provided by the detecting unit and provide the control instruction to the executing unit. The control instruction is used to control the first electronic apparatus to enter the first operating mode or the second operating mode.

The executing unit 400 is adapted to enter the first operating mode or the second operating mode according to the control instruction provided by the control instruction generating unit.

When the first electronic apparatus provided in the embodiment is in an operating state (the first operating mode or the second operating mode), the first electronic apparatus receives the state switching information fed back by the second electronic apparatus. The state switching information is a trigger condition for the first electronic apparatus to switch the operating mode; then the state of the second electronic apparatus is judged according to the state switching information; and the first electronic apparatus enters the corresponding operating mode automatically according to the judging result. Thereby it is avoided to select the mode every time the user uses the first electronic apparatus, thus the operation of the first electronic apparatus is simpler and it is more convenient for using the first electronic apparatus.

It should be noted that, the relationship terminologies such as the first and the second are only used herein to distinguish an entity or operation from another entity or operation, and it is not necessarily required or implied that there are any actual relationship or order among those entities and operations.

What are described above are only the specific embodiments of the present application. It should be noted that, multiple improvements and retouches may be made by those skilled in the art without departing from the principle of the present application, and these improvements and retouches also should fall within the protection scope of the present application.

1. An operation control method, applied to a first electronic apparatus, the first electronic apparatus having at least two operating modes which comprise a first operating mode and a second operating mode, wherein the first operating mode is an operating mode that the first electronic apparatus is in when a second electronic apparatus is in a first state; the second operating mode is different from the first operating mode and is an operating mode that the first electronic apparatus is in when the second electronic apparatus is in a second state, and the second state is different from the first state, wherein the method comprises:
detecting the state of the second electronic apparatus and obtaining a detection result;
generating a corresponding control instruction according to the detection result, wherein the control instruction is used to control the first electronic apparatus to enter the first operating mode or the second operating mode; and
entering the first operating mode or the second operating mode according to the control instruction.

2. The method according to claim 1, wherein
the first state of the second electronic apparatus comprises at least a first operating state, and the second state of the second electronic apparatus comprises at least a second operating state, the detecting the state of the second electronic apparatus and obtaining a detection result comprises:
detecting a communication state between the first electronic apparatus and the second electronic apparatus, and obtaining a first detection result if the communication state indicates that the second electronic apparatus is in the first operating state, wherein the first detection result is used to make the first electronic apparatus enter the first operating mode;
detecting the communication state between the second electronic apparatus and the first electronic apparatus, and obtaining a second detection result if the communication state indicates that the second electronic apparatus is in the second operating state, wherein the second detection result is used to make the first electronic apparatus enter the second operating mode; or,
the first state of the second electronic apparatus comprises a third operating state, the second state of the second electronic apparatus comprises a fourth operating state, and a first power consumption of the second electronic apparatus in the third operating state is less than a second power consumption of the second electronic apparatus in the fourth operating state, the detecting the state of the second electronic apparatus and obtaining a detection result comprises:
obtaining a first detection result if it is detected that the second electronic apparatus is in the third operating state, wherein the first detection result is used to make the first electronic apparatus enter the first operating mode;
obtaining a second detection result if it is detected that the second electronic apparatus is in the fourth operating state, wherein the second detection result is used to make the first electronic apparatus enter the second operating mode.

3. The method according to claim 2, wherein
a first control instruction is generated when the first detection result is obtained, the first control instruction is used to control the first electronic apparatus to enter the first operating mode, the first electronic apparatus in the first operating mode is adapted to receive a first predetermined operation and generate a first instruction, so that the first electronic apparatus executes the first instruction.

4. The method according to claim 2, wherein
a second control instruction is generated when the second detection result is obtained, the second control instruction is used to control the first electronic apparatus to enter the second operating mode, the first electronic apparatus in the second operating mode is adapted to receive a second predetermined operation, generate a second instruction and provide the second instruction to the second electronic apparatus, so that the second electronic apparatus executes the second instruction.

5. The method according to claim 1, wherein the first electronic apparatus has an overlap-arranged display unit, and the method further comprises, before the generating a corresponding control instruction according to the detection result,
displaying, by the display unit, operation prompt information for entering the first operating mode or the second operating mode, if it is detected that the second electronic apparatus is in the second state.

6. The method according to claim 2, wherein the first electronic apparatus has a display unit and a sensing unit which are overlap-arranged,
a first control instruction is generated when the first detection result is obtained, the first control instruction is used to control the first electronic apparatus to enter the first operating mode, and when the first electronic apparatus is in the first operating mode, the display unit outputs first prompt information, wherein the second electronic apparatus is switched from the first state to the second state after the sensing unit detects that the first prompt information is triggered;
a second control instruction is generated when the second detection result is obtained, the second control instruction is used to control the first electronic apparatus to enter the second operating mode, and when the first electronic apparatus is in the second operating mode, the display unit outputs second prompt information, wherein the second electronic apparatus is switched from the second state to the first state after the sensing unit detects that the second prompt information is triggered.

7. The method according to claim 1, wherein the first electronic apparatus comprises an input unit and has a third state and a fourth state, a third power consumption of the first electronic apparatus in the third state is less than a fourth power consumption of the first electronic apparatus in the fourth state, and the method further comprises, before the detecting the state of the second electronic apparatus,
receiving, by the input unit, an input operation for exiting the third state which is input by an operator, when the first electronic apparatus is in the third state.

8. The method according to claim 1, wherein the first electronic apparatus is in the second operating mode or the first operating mode, and the method further comprises, before the detecting the state of the second electronic apparatus,
receiving state switching feedback information from the second electronic apparatus; and
the detecting the state of the second electronic apparatus comprises:
detecting the state of the second electronic apparatus according to the received state switching feedback information.

9. A first electronic apparatus, which has at least two operating modes comprising a first operating mode and a second operating mode, wherein the first operating mode is an operating mode that the first electronic apparatus is in when a second electronic apparatus is in a first state; the second operating mode is different from the first operating mode and is an operating mode that the first electronic apparatus is in when the second electronic apparatus is in a second state, and the second state is different from the first state, the first electronic apparatus comprising:
a communicating unit, adapted to transmit data between the first electronic apparatus and the second electronic apparatus;
a detecting unit, adapted to detect the state of the second electronic apparatus according to information provided by the communicating unit, obtain a detection result and provide the detection result to a control instruction generating unit;
the control instruction generating unit, adapted to generate a corresponding control instruction according to the detection result provided by the detecting unit and provide the control instruction to an executing unit, wherein the control instruction is used to control the first electronic apparatus to enter the first operating mode or the second operating mode; and
the executing unit, adapted to enter the first operating mode or the second operating mode according to the control instruction provided by the control instruction generating unit.

10. The first electronic apparatus according to claim 9, wherein
the first state of the second electronic apparatus comprises at least a first operating state, and the second state of the second electronic apparatus comprises at least a second operating state, the detecting unit is adapted to:
obtain a communication state between the first electronic apparatus and the second electronic apparatus by the communicating unit, and obtain a first detection result if the communication state indicates that the second electronic apparatus is in the first operating state, wherein the first detection result is used to make the first electronic apparatus enter the first operating mode;
obtain a second detection result if the communication state indicates that the second electronic apparatus is in the second operating mode, wherein the second detection result is used to make the first electronic apparatus enter the second operating mode; or,
the first state of the second electronic apparatus comprises a third operating state, the second state of the second electronic apparatus comprises a fourth operating state, and a first power consumption of the second electronic apparatus in the third operating state is less than a second power consumption of the second electronic apparatus in the fourth operating state; the detecting unit is adapted to:
obtain a first detection result if it is detected that the second electronic apparatus is in the third operating state, wherein the first detection result is used to make the first electronic apparatus enter the first operating mode;
obtain a second detection result if it is detected that the second electronic apparatus is in the fourth operating state, wherein the second detection result is used to make the first electronic apparatus enter the second operating mode.

11. The first electronic apparatus according to claim 10, wherein the control instruction generating unit is adapted to:
generate a first control instruction when the first detection result provided by the detecting unit is obtained, the first control instruction is used to control the first electronic apparatus to enter the first operating mode, the first electronic apparatus in the first operating mode is adapted to receive a first predetermined operation and generate a first instruction, so that the first electronic apparatus executes the first instruction.

12. The first electronic apparatus according to claim 10, wherein the control instruction generating unit is adapted to:
generate a second control instruction when the second detection result provided by the detecting unit is obtained, the second control instruction is used to control the first electronic apparatus to enter the second operating mode, the first electronic apparatus in the second operating mode is adapted to receive a second predetermined operation, generate a second instruction and provide the second instruction to the second electronic apparatus, so that the second electronic apparatus executes the second instruction.

13. The first electronic apparatus according to claim 9, wherein the first electronic apparatus has a display unit and a sensing unit which are overlap-arranged,
the display unit is further adapted to display operation prompt information for entering the first operating mode or the second operating mode if it is detected that the second electronic apparatus is in the second state; and
the sensing unit is adapted to receive an input operation of an operator.

14. The first electronic apparatus according to claim 10, wherein the first electronic apparatus has a display unit and a sensing unit which are overlap-arranged,
the control instruction generating unit is adapted to generate a first control instruction if the first detection result provided by the detecting unit is obtained, the first control instruction is used to control the first electronic apparatus to enter the first operating mode;
generate a second control instruction if the second detection result provided by the detecting unit is obtained, the second control instruction is used to control the first electronic apparatus to enter the second operating mode;
the display unit is adapted to output first prompt information when the first electronic apparatus is in the first operating mode; output second prompt information when the first electronic apparatus is in the second operating mode;
the second electronic apparatus is switched from the first state to the second state after the sensing unit detects that the first prompt information is triggered;
the second electronic apparatus is switched from the second state to the first state after the sensing unit detects that the second prompt information is triggered.

15. The first electronic apparatus according to claim 9, wherein the first electronic apparatus has a third state and a fourth state, a third power consumption of the first electronic apparatus in the third state is less than a fourth power consumption of the first electronic apparatus in the fourth state, and the first electronic apparatus further comprises:
an input unit, adapted to receive an input operation for exiting the third state which is input by an operator, when the first electronic apparatus is in the third state.

16. The first electronic apparatus according to claim 9, wherein the first electronic apparatus is in the second operating mode or the first operating mode,
the communicating unit is further adapted to receive state switching feedback information from the second electronic apparatus; and
the detecting unit is adapted to detect and obtain the state of the second electronic apparatus according to the received state switching feedback information.
